(19) United States
(12) Patent Application Publication
(10) Pub. No.: US 2015/0351374 A1
(43) Pub. Date: Dec. 10, 2015

(54) TACKLE SYSTEM WITH REMOVABLE LURE ORGANIZER

(71) Applicant: Robert George Marek, Chicago, IL (US)

(72) Inventor: Robert George Marek, Chicago, IL (US)

(21) Appl. No.: 14/714,804

(22) Filed: May 18, 2015

Related U.S. Application Data
(63) Continuation-in-part of application No. 14/047,357, filed on Oct. 7, 2013.
(60) Provisional application No. 61/994,409, filed on May 16, 2014.

(51) Int. Cl. A01K 97/06

(52) U.S. Cl. CPC A01K 97/06

(57) ABSTRACT

A fishing tackle organizer, usable alone or as a fishing tackle system, provides convenient storage and display of fishing tackle. The organizer includes an elongated body having a plurality of sites for securing tackle and can be attached to a pallet which slides into a tackle box. The individual pallet tackle organizers may be individually portable or secured in the system within a tackle box, on a boat, a fishing dock or in a garage. The tackle system is customizable and may include at least one of the disclosed organizers fixed or detachably positioned on a pallet.

### RELATED APPLICATIONS

The present application claims the filing priority of U.S. Provisional Application No. 61/994,409 filed on May 16, 2014 and titled “Tackle Box With Removable Lure Organizer.” Further, this application is a Continuation-In-Part of U.S. application Ser. No. 14/047,357, titled “Fishing Lure Organizer and Tackle Box System,” filed Oct. 7, 2013. The '409 Provisional application and '357 Non-Provisional application are each hereby incorporated by reference.

### TECHNICAL FIELD OF THE INVENTION

The present invention relates to organizers for fishing lures of all shapes and sizes. More particularly, the invention relates to a customizable organizer system for such lures.

### BACKGROUND OF THE INVENTION

It is not uncommon for fisherman to own hundreds, even thousands of different fishing tackle, including lures, jigs, crankbait, bobbers, hooks, etc. Such fishing tackle is typically initially sorted and stored within multiple tackle boxes. With respect to fishing lures and crankbait, special shallow tackle boxes having dividers are used to help reduce an acceptable amount of tangling and chaos. Eventually, with the ever constant addition of new tackle, the tangle of single and multi-barbed hooks and different colored bodies and various shapes and sizes of fishing lures and hooks become too difficult, too common, and too much for even the most diligent fishermen. The result is a collection of tackle in complete disarray. Finding “just the right” lure becomes next to impossible.

Even for organized tackle boxes which allow for hanging of tackle, stability can be an issue which slows the selection process. For tournament fishermen, time can be a critical factor in competition. The need is not just for an organized tackle box, but for a feature that allows the full complement of a fisherman's tackle to be accessible during fishing. A stable and accessible location for the display of tackle would greatly enhance the experience as well.

In addition to the organization and time issues, most fish tackle, fresh from dangling in water for some time, is put away and stored wet. This can lead to odor, rust and even tackle degradation for some materials. Current tackle storage bins and boxes, even while providing drainage holes or slots, do not facilitate proper drying of tackle.

By providing a unique customized organizer with multiple beneficial features, the utility, accessibility, stability and overall sanitation and life of the tackle, as well as the enjoyment of the fishing experience by the user, are all greatly improved. Until the invention of the present application, these and other problems in the prior art went either unnoticed or unsolved by those skilled in the art. The present invention provides unique organization, storage and stability to any fishing trip without sacrificing portability, design, style or affordability.

### SUMMARY OF THE INVENTION

There are disclosed herein an improved tackle organizer and organizer system which avoid the disadvantages of prior devices and systems while affording additional structural and operating advantages.

Generally speaking, the disclosed tackle organizer is comprised of a substantially planar first body, a second body having a plurality of sites for securing tackle, an attachment member for detachably affixing the second body to the first body, and a securing member to prevent removal of tackle from a storage site. The sites are preferably provided with holes spaced on an upper surface of the second body. Such holes may be added by the user as a customizing feature of the invention.

In a specific embodiment, the attachment member is comprised of a threaded bolt and wing nut (or similar device) which passes through or into the first and second bodies to secure the latter to the former. Numerous alternative attachment members may be used to detachably secure a second body to the first body. Vertical slots (preferably three) on the first body allow for the attachment of numerous second bodies, as well as allowing for movement up and down of attached bodies for spacing, as required.

In another specific embodiment, a lid attaches to the second body to provide a preferred securing member when it is closed about the plurality of tackle sites. Preferably, the lid is hinged to the second body, but may be tethered in any manner to minimize the risk of loss. Further, a surface of the second body may be recessed to permit closing of a lid without interference from seated tackle. As an additional feature of the lid, a flange may extend substantially perpendicular to the surface of the second body to further protect and retain hanging tackle, and reduce the risk of hooks becoming snagged in clothing, fingers, etc.

In an embodiment of the organizer system, housing is provided for storage of at least one first body. Particular housing may be configured with an open top or open side to allow insertion of a first body into a slotted position. A number of slotted positions may be provided within the housing, as needed.

These and other aspects of the invention may be understood more readily from the following description and the appended drawings.

### BRIEF DESCRIPTION OF THE APPENDED DRAWINGS

For the purpose of facilitating an understanding of the subject matter sought to be protected, there are illustrated in the accompanying drawings, embodiments thereof, from an inspection of which, when considered in connection with the following description, the subject matter sought to be protected, its construction and operation, and many of its advantages should be readily understood and appreciated by those of ordinary skill in the art.

FIG. 1 is a perspective view of an embodiment of a tackle storage shelf of the disclosed invention;

FIG. 2 is a top view of the tackle storage shelf of FIG. 1;

FIG. 3 is a front view of the tackle storage shelf of FIG. 1;

FIG. 4 is a perspective view of another embodiment of a tackle storage shelf of the disclosed invention;

FIG. 5 is a perspective view of still another embodiment of a tackle storage shelf of the disclosed invention;

FIG. 6 is a top view of the tackle storage shelf of FIG. 5;

FIG. 7 is a front view of the tackle storage shelf of FIG. 5;

FIG. 8 is a side view of a tackle storage shelf illustrating a locking lid feature;

FIG. 9 is a side view of a tackle storage shelf illustrating a locking lid feature;

FIG. 10 is a perspective view of an embodiment of the tackle storage shelf including a hinged lid with a protective extension;

FIGS. 11(a)-(e) are several different views of a tackle storage shelf having a protective extension from the lid;

FIG. 12 is a front view of an embodiment of a storage pallet in accordance with the disclosed invention;

FIGS. 13(a)-(b) are different views of a storage pallet;

FIG. 14 is a front perspective view of an embodiment of an organizer in accordance with the present disclosure;

FIG. 15 is a close-up of the organizer of FIG. 14;

FIG. 16 is a schematic illustration of an embodiment of the disclosed tackle storage system;

FIG. 17 is another schematic illustration of an embodiment of the disclosed tackle storage system; and

FIG. 18 is a schematic illustration of an interior of housing for the disclosed tackle storage system of FIG. 16.

### DETAILED DESCRIPTION OF THE INVENTION

While this invention is susceptible of embodiments in many different forms, there is shown in the appended drawings and will herein be described in detail at least one preferred embodiment of the invention with the understanding that the present disclosure is to be considered as an exemplification of the principles of the invention and is not intended to limit the broad aspect of the invention to any of the specific embodiments illustrated.

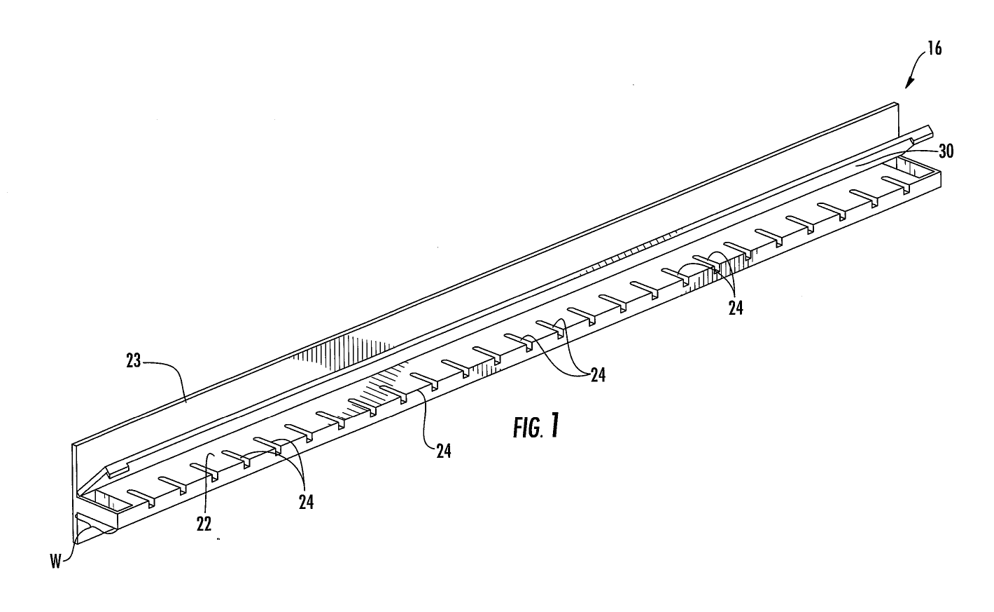

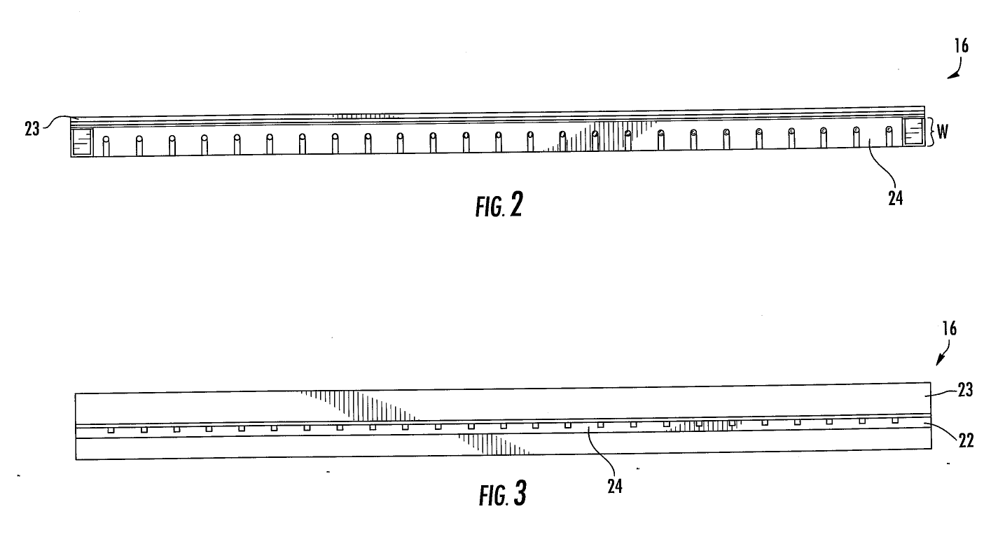

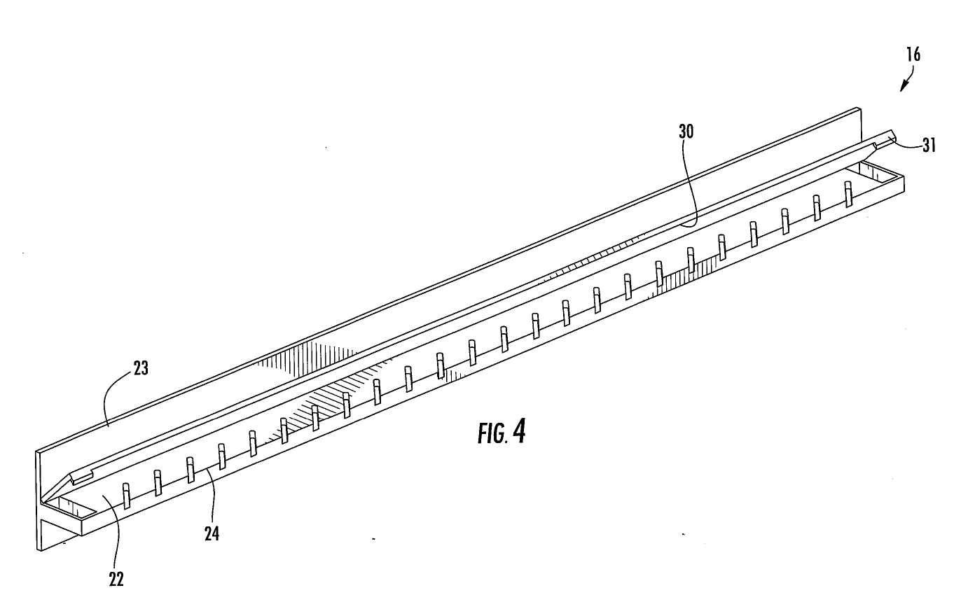

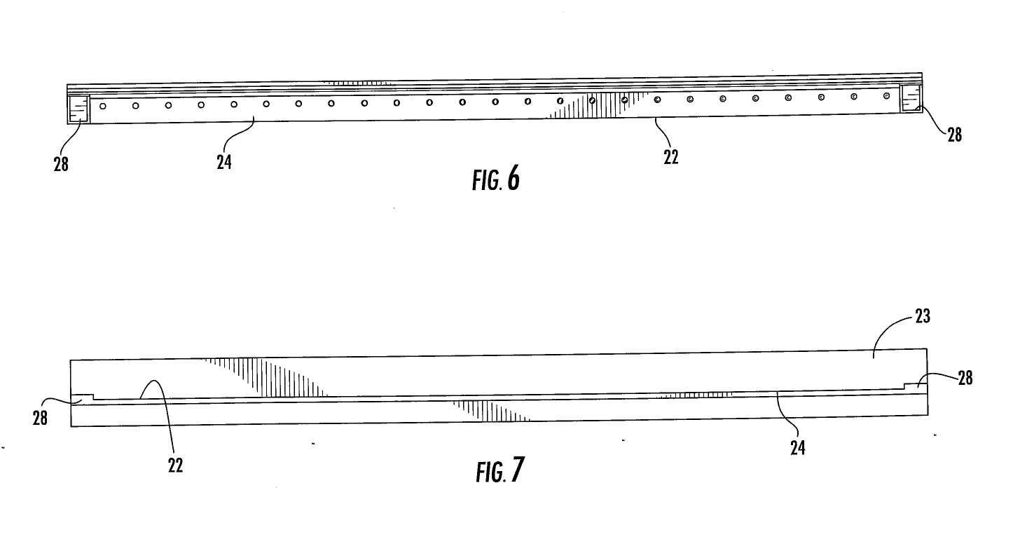

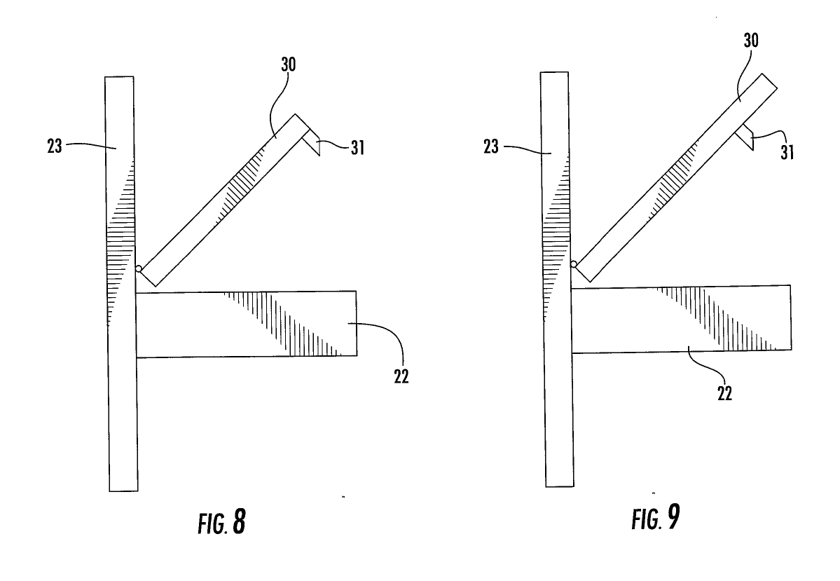

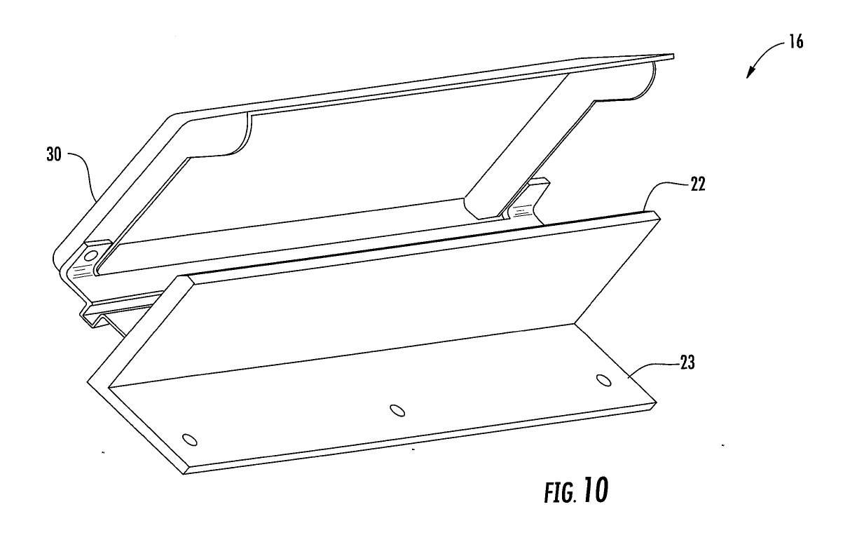

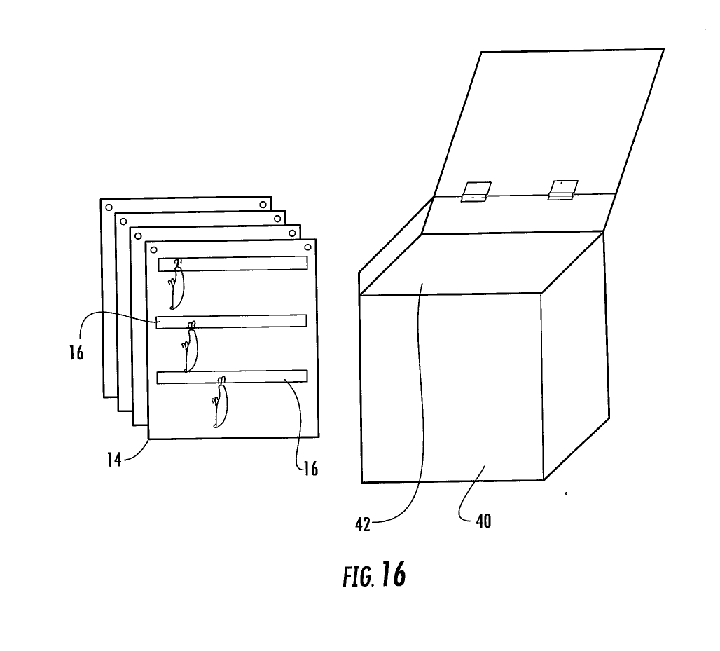

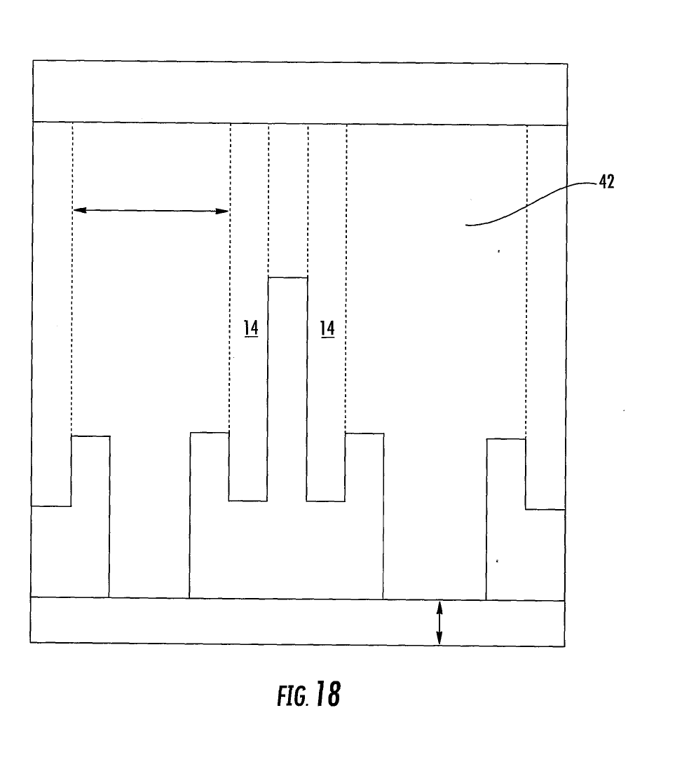

Referring to FIGS. 1-18, there is illustrated at least one embodiment of a fishing tackle organizer and a fishing tackle system. The organizer, generally designated by the numeral 10, and tackle system, generally designated by the numeral 12, are capable of including a number of unique features and components. Accordingly, while not all embodiments are shown or described as including all possible unique features and components, those skilled in the art would understand from the following description in conjunction with the appended drawing, the numerous combinations and variations possible. In all embodiments, similar features have been indicated using the same reference number in the drawings and the following detailed description.

A key feature of the described organizer 10 is that it can be customized to a specific tackle considering size dimensions and the shape of the tackle. That is, fishing tackle can categorized based on size—e.g., for large fish, medium fish and small fish—as well as by the type of tackle—e.g., spinners, jigs, crankbait, etc. Other features of the organizer 10 and tackle system 12 will be apparent from the various embodiments described.

While all the embodiments illustrated are directed to an organizer and system for specific hooked fishing tackle, it should be understood that the principles of the invention may be more broadly applied to a storage system for most any type of fishing tackle, as long as such tackle is suitable for securing in an embodiment of the disclosed customized organizer 10.

The organizer 10 includes several features and advantages which can be more readily understood from the appended drawings. The organizer 10 is preferably comprised of at least one second body 16 (aka “shelf”) which detachably secures to a rectangular (first) body 14 (aka “pallet”) having opposing first and second surfaces.

Beginning with the second body or shelf 16, several embodiments of which are illustrated in FIGS. 1-11, it is preferably comprised of an L-shaped bar which includes an upper surface 22 having a plurality of tackle storage sites 24 thereon, and back surface 23. Each storage site 24 is preferably comprised of a hole passing through the surface 22. The spacing and position (relative to the edge of the body) of each hole may be customized for specific tackle, as defined above. For example, No. 2 hooks are small so the holes could be smaller with minimal spacing, while No. 10 hooks are larger and the holes would necessarily be larger and spaced farther apart. Of course, the width (W) of the body can be varied to accommodate hook sizes as well. Though not shown, it is possible that the shelf 16 can be provided with a range of different holes to accommodate an assortment of hook sizes. Such a shelf 16 could benefit “novice” fisherman having a limited amount of tackle or an angler who wants to use only a limited number of various sized lures. The customizing may be done pre- or post-sale—that is, by the manufacturer or by the consumer. Templates could be made available to guide users in adding holes.

A lid 30 provides a securing member to prevent tackle from being removed, especially accidentally removed, from the shelf 16. Making the lid 30 hinged or at least tethered to the second body/shelf 16 helps prevent loss of a detached lid. Also, the lid 30 should be able to “lock” onto the shelf 16 when closed. Molded locking flanges 31 are preferred. However, this feature can be accomplished in any number of known ways including, but not limited to, using small bumps and detents on the overlapping surfaces.

When secured over the surface of the second body, any seated tackle is prevented from exiting a hole. To provide the proper spacing for seated tackle when the lid is closed, the surface may be recessed, as shown in FIG. 5, or individual slots in the surface may be connected to each hole. The slots may be placed at an angle to further inhibit lures from being undesirably dislodged. The angle for each site can alternate and are preferably in a range of about ±10-45° off perpendicular.

In another alternative, the underside of lid 30 may be contoured to provide a gap or slotted to prevent interference with tackle when closed over the second body.

From a manufacturing standpoint, the recessed surface embodiment may be easier and less expensive to produce. As can be seen in FIG. 5, end caps 28 for the shelf 16 are above the surface 22 having holes. Accordingly, when the lid 30 is closed, a small gap is created between the surface 22 and the underside of the lid 30. The gap should be just large enough to allow hooks within the holes to rise above the surface 22 without impeding the lid 30. As before, the size of the gap can be customized to accommodate different sizes and types of lures.

Alternatively, the shelf 16 may have no gap, but may instead include a piece of single-sided foam tape on the underside of the door panel, glue side of tape attached to the underside of the door. When the hook is resting in the hole and the door gets moved to a closed position, the opposing side of the foam tape is forced to compress around the hook and a seal around the hook is created by the foam. This helps to prevent the hook from moving. The tape does not need to be very thick, maybe just 1/16″ (about 1-3 mm) or so, just enough to create a seal around the hook so that it cannot move, yet thin enough to allow for locks on the lid to engage.

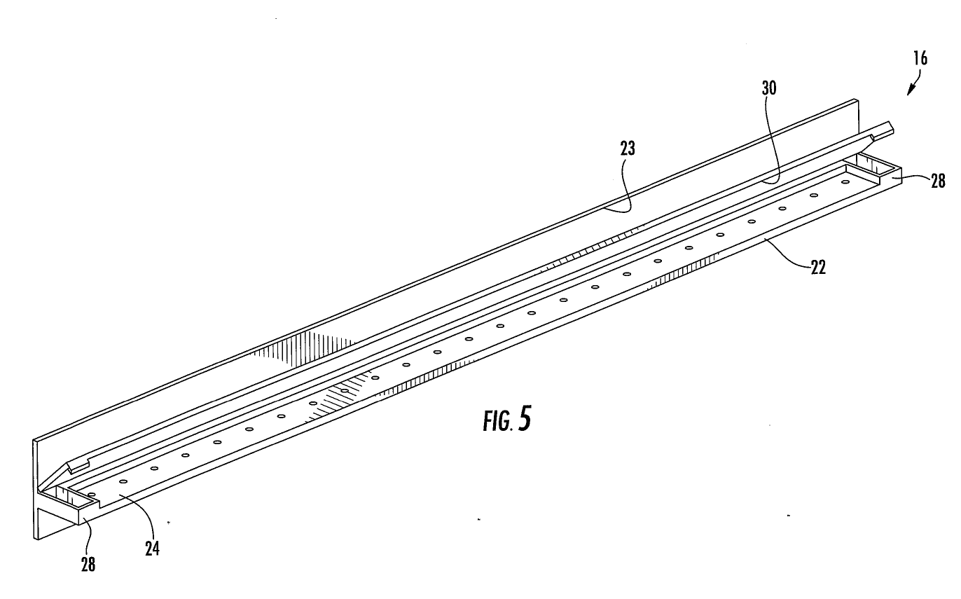

As shown, the lid 30 is preferably attached via a hinge (preferably a “living” hinge) at the junction of the upper surface 22 and a back surface. The lid 30 closes over the body 16 to hold in the various tackle when not in use. The lid 30 prevents hooks from “jumping” out of the lure sites. The lid 30 may include a biasing spring to maintain the panel in a closed position, and/or it may utilize some form of clip/snap mechanism 31 (see FIGS. 4, 8 and 9) to hold the lid 30 closed. Magnets can also be used to retain the lid 30 in a closed position.

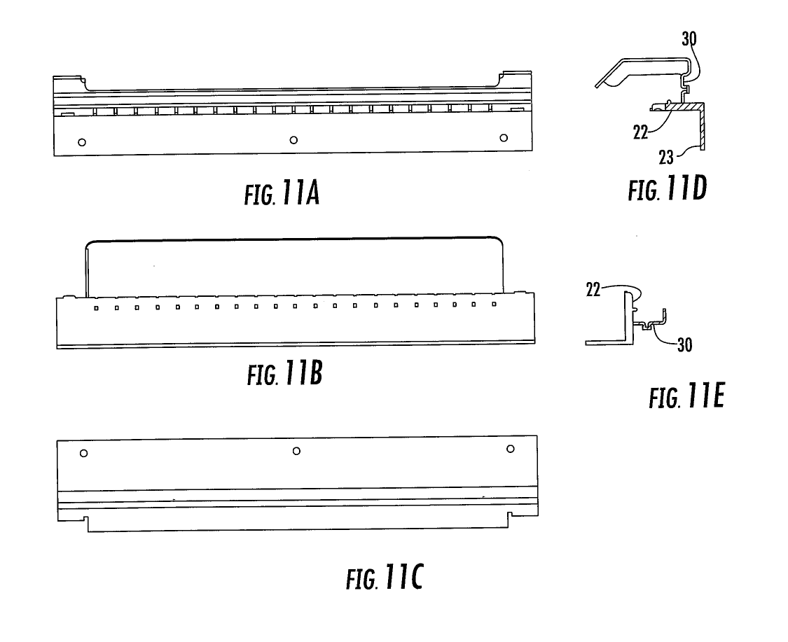

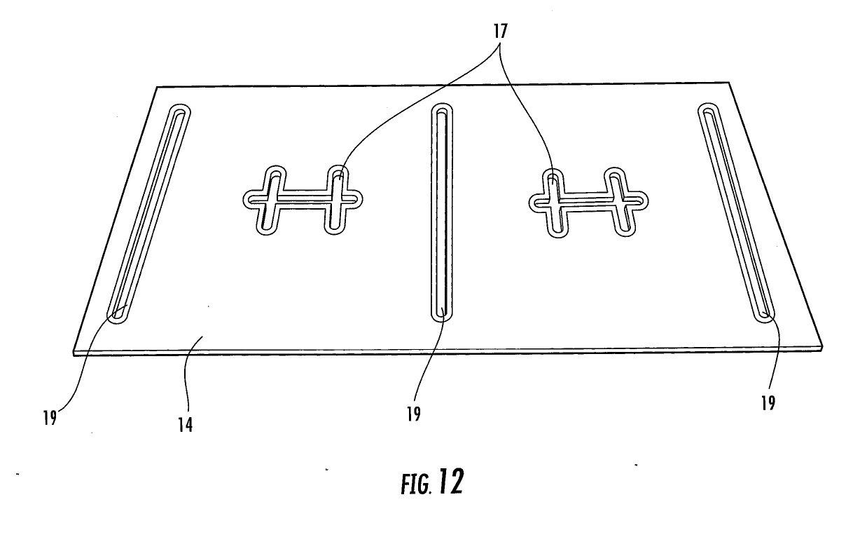

The lid 30 may also be extended outward and/or downward, as shown in FIGS. 10-11, where larger hooks/lures are retained. The extension of the lid 30 is used to keep seated lures from swinging about and becoming entangled with other lures or other tackle.

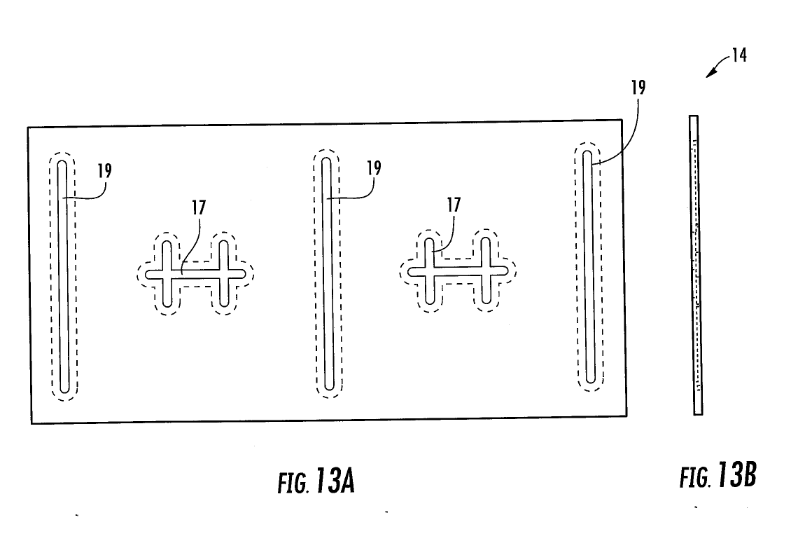

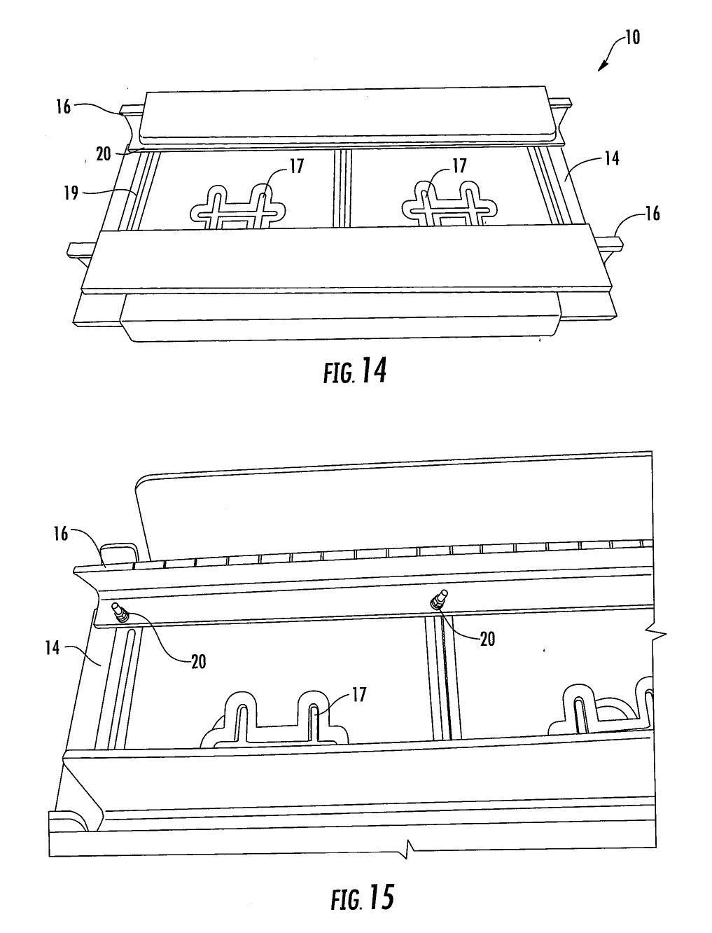

As for the first body or pallet 14, it is comprised of a relatively thin panel having specific dimensions for proper storage, as will be described below. As shown in FIGS. 12 and 13, the rectangular body 14 preferably includes two sets of attachment slots, 17 and 19. The body may be comprised of most any material, though a treated metal or strong plastic material is preferred, as these materials stand up best against water damage.

Attachment slots 17 allow the first body 14 to be attached to a support in a manner similar to hanging a picture. This allows a fisherman to place a pallet in a location which is most suitable for his/her fishing needs. It will also allow the pallet to be hung for display or storage, as desired. In the illustrated embodiment, the slots 17 form an “H” on the pallet 14 to provide greater flexibility for attachment to a support, as would be understood by those skilled in the art. Obviously, other slot configurations are available for specific and general purposes.

The three vertical attachment slots 19 allow a second body 16 to be attached to the first body 14 via the securing member 20. As illustrated, the securing member is preferably a series of nuts and bolts which pass through the first body 14 and the second body 16 to secure the two together. However, there are a variety of means and methods by which the two bodies may be detachably affixed to one another. The vertical slots 19 allow an attached body 16 to be moved up and down on the pallet 14 and also allow numerous bodies to be attached by altering the spacing.

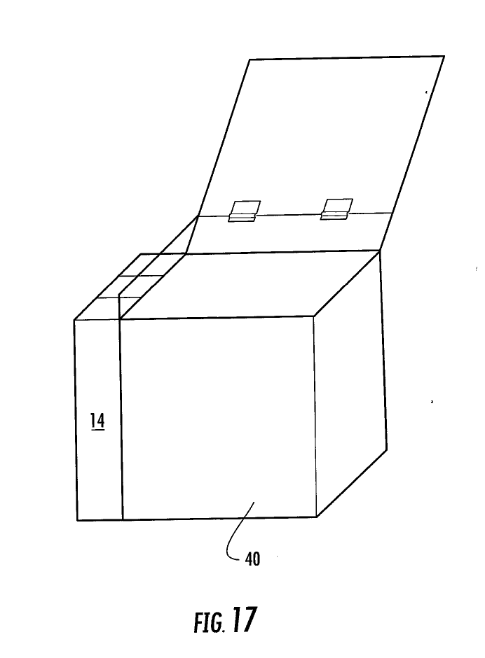

Referring now to FIGS. 16-18, preferred embodiments of the organizer system 12 illustrate the use of a housing 40 for storage of pallets 14. The housing 40 can be used to contain a plurality of pallets 12 therein, whether they contain shelves 16 or not. The housing 40 being comprised of a series of top, bottom, and side walls would also include a large open area 42 to allow access to storage slots 44 in the interior. The open area 42 preferably extends a substantial length of the housing 40. This may provide a suitable area in which to view stored tackle.

In an embodiment of the tackle system 12, a plurality of organizing pallets 14 are shown alongside housing 40, e.g., a tackle box. Each of the pallets 14 may include at least one detachable or permanently affixed shelf 16, as described above. The pallets 14 slide easily into the tackle box for storage when not in use. A pallet 14 can be removed from the tackle box and attached to a surface allowing easy access to the organized lures. Other means for hanging the pallets on the side of the tackle box, or elsewhere, may be used. Further, several sides of the tackle box may include hanging means so that the user can have access to more than one pallet.

Each of the disclosed components, the pallet 14, the shelf 16 and the housing 40 can be used individually in the myriad of possible embodiments for each. Such components would provide numerous advantages and improvements over existing organizers and tackle storage systems. However, as a complete system, including all three components, the greatest advantages and improvements are best realized.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. A fishing tackle organizer comprising:
a substantially planar first body having first and second surfaces and configured for attachment to a support;
a second body having a predetermined length, an upper surface and a plurality of tackle storage sites defined therein;
an attachment member for detachably affixing the second body to the first surface of the first body in a manner which provides access to the plurality of tackle storage sites; and
a securing member attachable to the second body and configured to prevent removal of tackle placed in a storage site.

2. The fishing tackle organizer of claim 1, wherein the first body comprises at least a first slot for adjustable attachment of the second body via the attachment member.

3. The fishing tackle organizer of claim 2, wherein the attachment member comprises an elongated member which passes through the second body and the first slot.

4. The fishing tackle organizer of claim 1, wherein the securing member comprises a lid configured to cover the upper surface of the second body.

5. The fishing tackle organizer of claim 4, wherein the lid comprises an extension which extends substantially perpendicular to the lid to further restrain movement of tackle in the storage sites.

6. The fishing tackle organizer of claim 1, wherein each of the plurality of tackle storage sites comprises a hole through the upper surface of the second body.

7. The fishing tackle organizer of claim 6, wherein the each of the plurality of tackle storage sites further comprises a channel extending to an outer edge of the upper surface from each hole.

8. The fishing tackle organizer of claim 1, further comprising at least one template for marking desired holes in at least some of the plurality of tackle storage sites.

9. The fishing tackle organizer of claim 1, further comprising at least one additional second body detachable affixed to the first body via a securing member.

10. The fishing tackle organizer of claim 1, further comprising a housing having a plurality of walls defining an interior and having a plurality of slots therein, wherein each slot is configured to accommodate a first body.

11. The fishing tackle organizer of claim 10, wherein the housing has a side opening for inserting a first body into a slot.

12. The fishing tackle organizer of claim 1, wherein the upper surface of the second body is recessed to create a gap when the lid is attached.

13. A fishing tackle organizer system comprising:
a housing having a plurality of walls defining an interior and having a plurality of slots therein;
at least one substantially planar first body having first and second surfaces and configured for insertion into any of the plurality of slots within the housing;
a second body having a predetermined length, an upper surface and a plurality of tackle storage sites defined therein;
an attachment member for detachably affixing the second body to the first surface of the first body in a manner which provides access to the plurality of tackle storage sites; and
a securing member attached to the second body and configured to prevent removal of tackle placed in a storage site.

14. The fishing tackle organizer system of claim 13, wherein the first body comprises at least a first slot for adjustable attachment of the second body via the attachment member.

15. The fishing tackle organizer of claim 14, wherein the attachment member comprises an elongated member which passes through the second body and the first slot.

16. The fishing tackle organizer of claim 13, wherein the securing member comprises a lid configured to cover the upper surface of the second body.

17. The fishing tackle organizer of claim 16, wherein the lid comprises an extension which extends substantially perpendicular to the lid to further restrain movement of tackle in the storage sites.

18. The fishing tackle organizer of claim 13, wherein each of the plurality of tackle storage sites comprises a hole through the upper surface of the second body.

19. The fishing tackle organizer of claim 18, wherein the each of the plurality of tackle storage sites further comprises a channel extending to an outer edge of the upper surface from each hole.

20. The fishing tackle organizer of claim 13, further comprising at least one template for marking desired holes in at least some of the plurality of tackle storage sites.
